(19) United States
(12) Patent Application Publication
(10) Pub. No.: US 2025/0287157 A1
(43) Pub. Date: Sep. 11, 2025

(54) UTILIZING CAPACITORS ON A CHIP OF A CAPACITIVE SENSING DEVICE

(71) Applicant: INVENSENSE, INC., San Jose, CA (US)

(72) Inventors: Chung-Hsien Lin, Hsinchu City (TW); Joseph Seeger, MENLO PARK, CA (US)

(21) Appl. No.: 19/072,417

(22) Filed: Mar. 6, 2025

Related U.S. Application Data
(63) Continuation-in-part of application No. 18/953,016, filed on Nov. 19, 2024.
(60) Provisional application No. 63/562,509, filed on Mar. 7, 2024.

(51) Int. Cl. H04R 19/04; H04R 1/04; H04R 19/00

(52) U.S. Cl. CPC H04R 19/04; H04R 1/04; H04R 19/005; H04R 2201/003

(57) ABSTRACT

On-chip capacitors of a micro-electro-mechanical system (MEMS) sensor are presented herein. The MEMS sensor comprises a MEMS chip comprising a capacitor with a dielectric comprising a defined leakage characteristic; and a capacitive sense element comprising a first and second sense nodes, a backplate, and a diaphragm. The first sense node is electrically connected to a first bond pad of the MEMS chip and is biased via a defined bias voltage that is externally applied to the first bond pad. The first sense node is electrically connected to a first node of the capacitor; a second node of the capacitor is electrically connected to a second bond pad of the MEMS chip; and the second sense node is electrically connected to a third bond pad of the MEMS chip. A semiconductor chip comprises an amplifier that is electrically connected to the second bond pad.

### CROSS-REFERENCE TO RELATED APPLICATION

This patent application is a continuation-in-part of U.S. patent application Ser. No. 18/953,016, filed on Nov. 19, 2024, and entitled “SEALED CAVITY FOR A CAPACITIVE SENSING DEVICE”, which claims priority to Provisional patent application No. 63/562,509, filed on Mar. 7, 2024, and entitled “VACUUM CAVITY FOR CAPACITIVE SENSING MICROPHONE,” the entirety of which applications are hereby incorporated by reference herein.

### TECHNICAL FIELD

This disclosure generally relates to embodiments for utilizing capacitors on a chip of a capacitive sensing device.

### BACKGROUND

A conventional microphone, e.g., micro-electromechanical system (MEMS) microphone, utilizes a membrane and a backplate to sense sound. The membrane is susceptible to breaking and/or cracking when larger pressures are applied to the membrane. Moreover, gaps in a structure, e.g., a vent hole corresponding to the membrane, and/or a perforated backplate, allow particles into a back volume of the microphone that can increase noise and negatively affect a signal-to-noise ratio (SNR) of the microphone.

Further, wiring resistance of bond wires used to couple capacitors of an application specific integrated circuit (ASIC) to a sensing element of the microphone can be significant (e.g., greater than 10 ohms), resulting in degradation of the SNR of the microphone. Consequently, conventional microphone technologies have had some drawbacks, some of which may be noted with reference to the various embodiments described herein.

### BRIEF DESCRIPTION OF THE DRAWINGS

Non-limiting embodiments of the subject disclosure are described with reference to the following figures, wherein like reference numerals refer to like parts throughout the various views unless otherwise specified:

FIG. 1 illustrates a block diagram of a MEMS sensor comprising a MEMS chip that is coupled, via wires, to a semiconductor chip, in which the MEMS chip comprises a group of capacitors, in accordance with various example embodiments;

FIG. 2 illustrates a schematic representation of a MEMS chip of a MEMS sensor, in which the MEMS chip comprises a group of capacitors, in accordance with various example embodiments;

FIG. 3 illustrates another schematic representation of a MEMS chip of a MEMS sensor, in which the MEMS chip comprises a group of capacitors, in accordance with various example embodiments;

FIG. 4 illustrates a schematic representation of a MEMS sensor, in which a capacitive sense element the MEMS sensor is placed in a feedback loop to improve a stability of the MEMS sensor, in accordance with various example embodiments;

FIG. 5 illustrates a schematic representation of a gain stage that is coupled to a capacitor within an architecture of a MEMS chip of a MEMS sensor, in which the gain stage and the capacitor are implemented in the MEMS chip as a capacitive divider, in accordance with various example embodiments;

FIG. 6 illustrates a schematic representation of an architecture of a MEMS chip of a MEMS sensor, in which gain stages that are coupled to respective capacitors of the MEMS sensor are implemented as respective capacitive dividers, in accordance with various example embodiments;

FIG. 7 illustrates a schematic representation of noise sources of a MEMS chip of a MEMS sensor, in accordance with various embodiments;

FIG. 8 illustrates a schematic representation of a MEMS chip of a MEMS sensor representing routing noise sources corresponding to switching noise of respective capacitances that are coupled to a capacitive sense element of the MEMS chip, in accordance with various embodiments; and

FIGS. 9-11 illustrate diagrams of cross-sections of respective MEMS chips of MEMS sensors in which the MEMS chips comprise on-chip capacitors, in accordance with various example embodiments.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

As described above, a membrane of a conventional microphone, e.g., MEMS microphone, is susceptible to breaking and/or cracking in response to larger pressures being applied to the membrane; and gap(s) in a structure, e.g., a vent hole, corresponding to the membrane, and/or in a perforated backplate of the microphone, allow particles into a back volume of the microphone that can increase noise and negatively affect an SNR of the microphone. Further, wiring resistance of bond wires used to couple capacitors of an ASIC to a MEMS sensing element of the microphone can be significant (e.g., greater than 10 ohms), resulting in further degradation of the SNR of the microphone.

Various embodiments disclosed can improve an SNR of the capacitive sensing device by integrating capacitors directly into a die/chip that includes the capacitive sensing device-eliminating noise corresponding to the capacitive sensing device that would have existed if the capacitors were included in an ASIC coupled, via wires, to the capacitive sensing device.

Moreover, integrating the capacitors directly into the die/chip can reduce parasitic effect(s), e.g., due to leakage current associated with applied high bias voltage(s), via improved process control over manufacturing parameters, e.g., dielectric properties, of the capacitors that are manufactured into the die/chip-further improving the SNR of the capacitive sensing device.

In embodiment(s), a MEMS sensor, comprises: a MEMS chip comprising a capacitor that comprises a dielectric comprising a defined leakage characteristic corresponding to a defined leakage resistance, and a capacitive sense element comprising a first sense element node and a second sense element node; the capacitive sense element comprises a backplate and a diaphragm and converts an external pressure that has been applied to the diaphragm into an electrical signal; and the first sense element node is electrically connected to a first bond pad of the MEMS chip and is biased via a defined bias voltage that is externally applied to the first bond pad.

Further, the first sense element node is electrically connected to a first node of the capacitor; a second node of the capacitor is electrically connected to a second bond pad of the MEMS chip; the second sense element node is electrically connected to a third bond pad of the MEMS chip; and the MEMS sensor further comprises a semiconductor chip comprising an amplifier that is electrically connected, via the second bond pad, to the second node of the capacitor.

In other embodiment(s), the capacitor is a first capacitor; the dielectric is a first dielectric; the defined leakage characteristic is a first defined leakage characteristic; the defined leakage resistance is a first defined leakage resistance; the MEMS chip further comprises a second capacitor that comprises a second dielectric comprising a second defined leakage characteristic corresponding to a second defined leakage resistance; the first sense element node is electrically connected to a first node of the second capacitor; and a second node of the second capacitor is electrically connected to a fourth bond pad of the MEMS chip.

In yet other embodiment(s), the fourth bond pad is electrically connected to a ground pad of the semiconductor chip.

In embodiment(s), the MEMS sensor further comprises a third capacitor that comprises a third dielectric comprising a third defined leakage characteristic corresponding to a third defined leakage resistance; a first node of the third capacitor is electrically connected to the first sense element node; and a second node of the third capacitor is electrically connected to a fifth bond pad of the MEMS chip.

In other embodiment(s), the semiconductor chip comprises a gain adjusting circuit that modifies gain on the MEMS sensor over a range of frequencies.

In yet other embodiment(s), the MEMS sensor of further comprises a fourth capacitor that comprises a fourth dielectric comprising a fourth defined leakage characteristic corresponding to a fourth defined leakage resistance; the second sense element node is electrically connected to a first node of the fourth capacitor; and a second node of the fourth capacitor is electrically connected to the fourth bond pad that is electrically connected to the second node of the second capacitor.

In embodiment(s), first dielectric properties of the first dielectric of the first capacitor are the same as third dielectric properties of the third dielectric of the third capacitor.

In other embodiment(s), second dielectric properties of the second dielectric of the second capacitor are the same as fourth dielectric properties of the fourth dielectric of the fourth capacitor.

In yet other embodiment(s), a low frequency corner (e.g., −3 dB corner) of a frequency response of the MEMS sensor is determined by the third capacitor.

In embodiment(s), a defined bias voltage is externally applied to the first bond pad such that the capacitive sense element operates in a negative capacitance region.

In other embodiment(s), the external pressure comprises a sound pressure, an atmospheric pressure, or an ultrasonic pressure.

In yet other embodiment(s), the capacitive sense element comprises a sealed cavity, e.g., comprising a pressure that is less than 100 pascals, which has been formed between the backplate and the diaphragm.

In embodiment(s), a shape of the diaphragm is circular, donut-shaped, or rectangular; and a portion of the backplate comprises an electrode comprising an array of pillars that is formed along the shape of the diaphragm.

In other embodiments, a MEMS device, e.g., a MEMS microphone, a MEMS pressure sensor, or a MEMS capacitive micromachined ultrasonic transducer, comprises: a MEMS chip comprising a first capacitor that comprises a first dielectric comprising a first defined leakage characteristic corresponding to a first defined leakage resistance; a second capacitor that comprises a second dielectric comprising a second defined leakage characteristic corresponding to a second defined leakage resistance; and a capacitive sense element comprising a first sense element node and a second sense element node.

Further, the capacitive sense element comprises a backplate and a diaphragm and converts an external pressure that has been applied to the diaphragm into an electrical signal; the first sense element node is electrically connected to a first bond pad of the MEMS chip, is biased via a defined bias voltage that is externally applied to the first bond pad, and is electrically connected to a first node of the first capacitor; the second sense element node is electrically connected to a first node of the second capacitor and a second bond pad of the MEMS chip; a second node of the first capacitor and a second node of the second capacitor are electrically connected to a third bond pad of the MEMS chip; and the MEMS sensor comprises a semiconductor chip comprising a ground pad that is electrically connected to the third bond pad of the MEMS chip.

In yet other embodiment(s), the MEMS chip further comprises: a third capacitor that comprises a third dielectric comprising a third defined leakage characteristic corresponding to a third defined leakage resistance; the first sense element node is electrically connected to a first node of the third capacitor; a second node of the third capacitor is electrically connected to a fourth bond pad of the MEMS chip; and an amplifier of the semiconductor chip is electrically connected, via the fourth bond pad, to the second node of the third capacitor.

In embodiment(s), the MEMS device further comprises a fourth capacitor that comprises a fourth dielectric comprising a fourth defined leakage characteristic corresponding to a fourth defined leakage resistance; a first node of the fourth capacitor is electrically connected to the first sense element node; and a second node of the fourth capacitor is electrically connected to a fifth bond pad of the MEMS chip.

In other embodiment(s), the semiconductor chip comprises a gain adjusting circuit that modifies a gain of the MEMS sensor.

In yet other embodiment(s), a low frequency corner of a frequency response of the MEMS sensor is determined by the fourth capacitor.

In embodiment(s), the third dielectric properties of the third dielectric of the third capacitor are equivalent to the fourth dielectric properties of the fourth dielectric of the fourth capacitor.

In other embodiment(s), the first dielectric properties of the first dielectric of the first capacitor are equivalent to the second dielectric properties of the second dielectric of the second capacitor.

In yet other embodiment(s), the defined bias voltage is externally applied to the first bond pad such that the capacitive sense element operates in a negative capacitance region.

In embodiment(s), the external pressure comprises a sound pressure, an atmospheric pressure, or an ultrasonic pressure.

In other embodiment(s), the capacitive sense element comprises a sealed cavity, e.g., comprising a pressure that is less than 100 pascals, which has been formed between the backplate and the diaphragm.

In yet other embodiment(s), a shape of the diaphragm is circular, donut-shaped, or rectangular; and a portion of the backplate comprises an electrode comprising an array of pillars that is formed along the shape of the diaphragm.

In embodiments, a MEMS sensor comprises: a substrate layer comprising an acoustic port and a capacitive sense element that comprises a backplate layer and a diaphragm layer. The capacitive sense element converts an external pressure that has been applied to the diaphragm layer via the acoustic port into an electrical signal; and the backplate layer and the diaphragm layer are disposed over the substrate layer. The MEMS sensor further comprises a capacitor comprising a dielectric layer that is disposed between a portion of the substrate layer and the diaphragm layer.

In other embodiment(s), the diaphragm layer comprises polysilicon, epi-silicon, and/or silicon-germanium.

In yet other embodiment(s), the dielectric layer is a first dielectric layer; and the MEMS sensor further comprises a polysilicon layer that is disposed over the diaphragm layer, and a second capacitor comprising a second dielectric layer that is disposed between the diaphragm layer and the polysilicon layer.

In embodiment(s), the MEMS sensor further comprises a second polysilicon layer that is disposed between the diaphragm and the backplate; and a second capacitor comprising a second dielectric layer that is disposed on the second polysilicon layer and the backplate.

In other embodiment(s), the first dielectric layer and the second dielectric layer comprise respective dielectric materials comprising respective defined leakage characteristics corresponding to respective defined leakage resistances.

In yet other embodiment(s), the respective dielectric materials comprise a thermal silicon dioxide and/or a high stress silicon nitride.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

Furthermore, to the extent that the terms “includes,” “has,” “contains,” and other similar words are used in either the detailed description or the appended claims, such terms are intended to be inclusive—in a manner similar to the term “comprising” as an open transition word-without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Furthermore, the word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art.

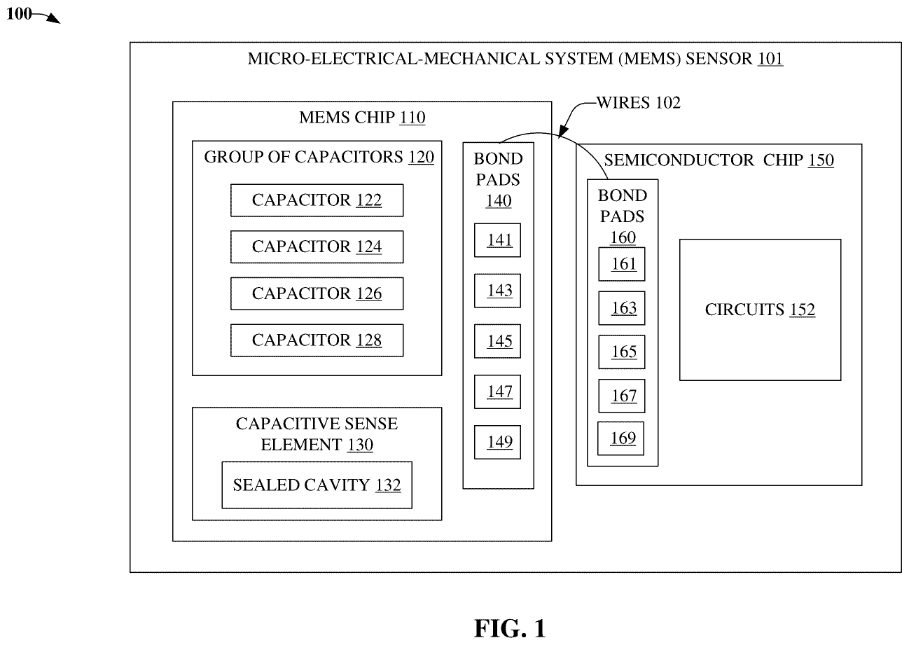

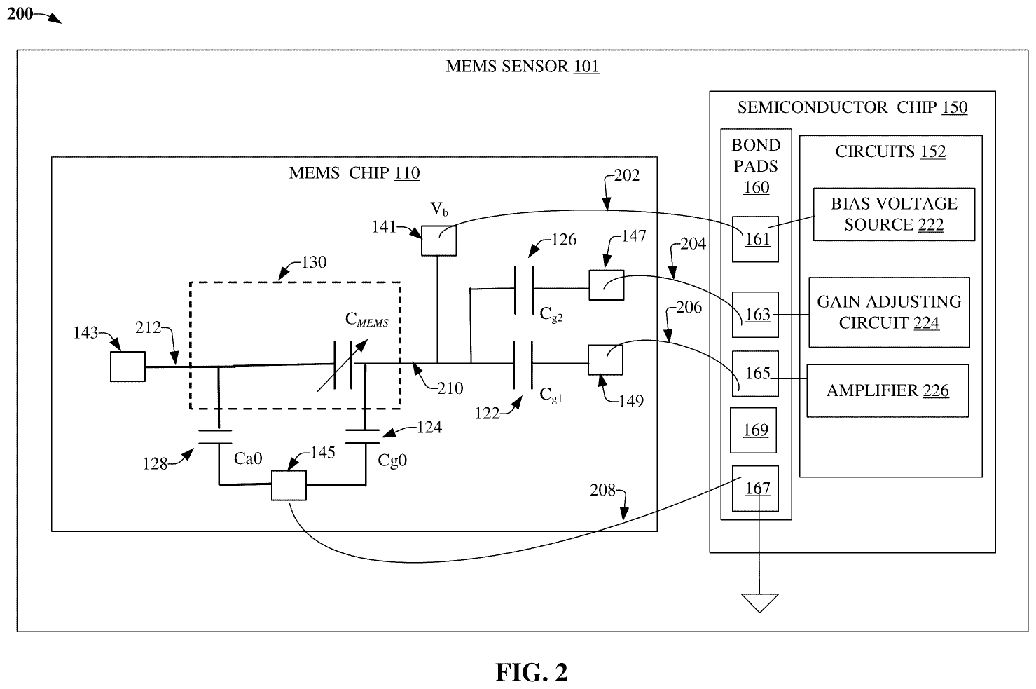

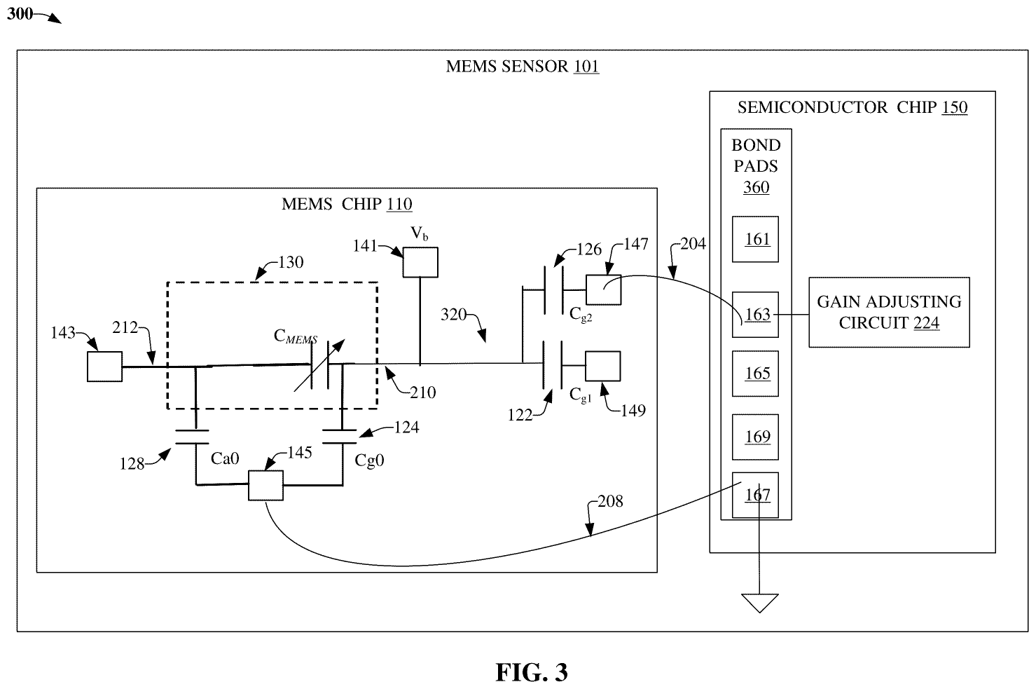

Referring now to FIGS. 1 and 2, FIG. 1 illustrates a block diagram (100) of a MEMS sensor (101) comprising a MEMS chip (110) that is coupled, via wires (102), to a semiconductor chip (150); and FIG. 2 illustrates a schematic representation (200) of the MEMS chip, in accordance with various example embodiments.

The MEMS chip comprises a group of capacitors (120) (e.g., capacitor 122 (“C_{g1}”), capacitor 124 (“C_{g0}”), capacitor 126 (“C_{g2}”), and capacitor 128 (“Cₐ₀”)); a capacitive sense element (130); and bond pads (140) (e.g., 141, 143, 145, 147, 149). The capacitive sense element (130) comprises a sealed cavity 132, and can be represented as a variable capacitor (“C_{MEMS}”). Alternately, the capacitive sense element (130) can be represented as a small signal voltage source (“Vsig”) and small signal capacitance (“C_{sig}”).

The semiconductor chip comprises bond pads 160 (e.g., 161, 163, 165, 167, 169). Bond pads 140 are connected via bond wires to bond pads 160. The group of capacitors (120) are formed on the MEMS chip to reduce leakage resistance—thereby reducing signal noise—and comprise respective dielectric properties comprising respective defined leakage characteristics corresponding to respective defined leakage resistances.

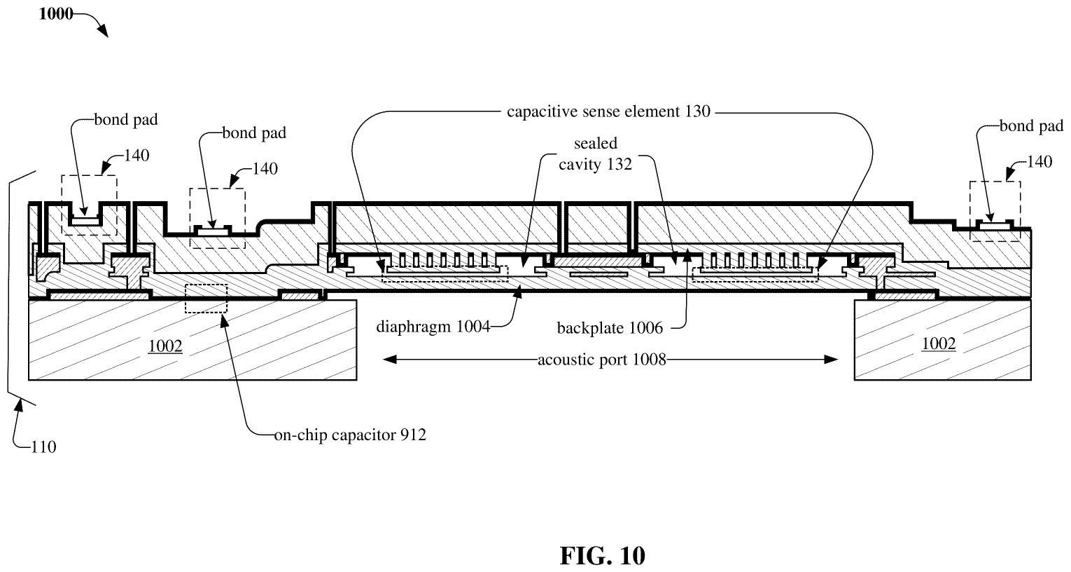

The capacitive sense element comprises a first sense element node (210), a second sense element node (212), and a backplate (see, e.g., 1006 in FIG. 10) and a diaphragm (see, e.g., 1004 in FIG. 10); and converts an external pressure that has been applied to the diaphragm into an electrical signal.

In some embodiments, a shape of the diaphragm is circular, donut-shaped, or rectangular, and a portion of the backplate comprises an electrode comprising an array of pillars that is formed along the shape of the diaphragm. In other embodiments, the external pressure comprises a sound pressure, an atmospheric pressure, or an ultrasonic pressure.

In yet other embodiments, the capacitive sense element comprises a sealed cavity (132) that has been formed between the backplate and the diaphragm. In embodiments, the sealed cavity comprises a pressure that is less than 100 pascals.

In an embodiment, the first sense element node is electrically connected to a first bond pad (141) of the MEMS chip, and is biased via a defined bias voltage (“V_{b}”) that is applied from the semiconductor chip 150 via bond pad 161 to the first bond pad (141). Further, the first sense element node is electrically connected to a first node of a capacitor (122) (C_{g1})).

In another embodiment, a second node of the capacitor (122) is electrically connected to a second bond pad (149) of the MEMS chip, and the second sense element node is electrically connected to a fifth bond pad on the semiconductor chip (e.g., 169) via a third bond pad (143) of the MEMS chip.

In yet another embodiment, an amplifier (226) of the semiconductor chip is electrically connected, via a pond bad (165) of the semiconductor chip and the second bond pad (149) of the MEMS chip, to the second node of the capacitor (C_{g1}).

In one embodiment, the capacitor is a first capacitor (C_{g1}), the dielectric is a first dielectric, the defined leakage characteristic is a first defined leakage characteristic, the defined leakage resistance is a first defined leakage resistance, and the MEMS chip further comprises a second capacitor (124 (C_{g0})) that comprises a second dielectric comprising a second defined leakage characteristic corresponding to a second defined leakage resistance. In this regard, the first sense element node (210) is electrically connected to a first node of the second capacitor (C_{g0}), and a second node of the second capacitor is electrically connected to a fourth bond pad (145) of the MEMS chip.

In an embodiment, the fourth bond pad (145) is electrically connected to a ground pad (167) of the semiconductor chip that is coupled to a ground potential of the MEMS sensor.

In another embodiment, the MEMS chip further comprises a third capacitor (126 (C_{g2})) that comprises a third dielectric comprising a third defined leakage characteristic corresponding to a third defined leakage resistance. A first node of the third capacitor (C_{g2}) is electrically connected to the first sense element node (210), and a second node of the third capacitor is electrically connected to a fifth bond pad (147) of the MEMS chip.

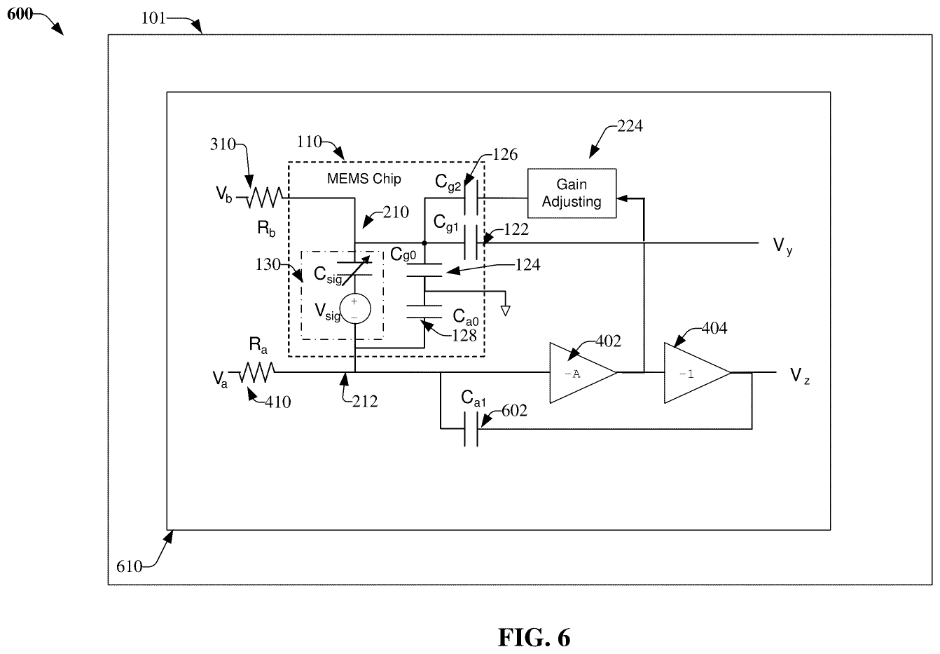

In yet another embodiment, the semiconductor chip comprises a first circuit (e.g., a gain adjusting circuit (224)) that modifies a gain of the MEMS sensor over the operating frequencies (see, e.g., schematic representation illustrated by FIG. 6 and described below) of the MEMS chip corresponding to the capacitive sense element according to a configuration, via the second bond pad and the fifth bond pad, of respective connections associated with the first capacitor (C_{g1}) and the third capacitor (C_{g2}).

In one embodiment, the MEMS chip further comprises a fourth capacitor (128 (Cₐ₀)) that comprises a fourth dielectric comprising a fourth defined leakage characteristic corresponding to a fourth defined leakage resistance. The second sense element node (120) is electrically connected to a first node of the fourth capacitor (Cₐ₀); and a second node of the fourth capacitor is electrically connected to the fourth bond pad (145) of the MEMS chip that is electrically connected to the second node of the second capacitor (C_{g0}), and further electrically connected to the ground pad (167) of the semiconductor chip.

In this regard, the second nodes of second capacitor (C_{g0}) and the fourth capacitor (Cₐ₀) are electrically coupled to a common node (e.g., bond pad 145). Resistance in series with Cₐ₀ or C_{g0} contributes to noise, and such noise can be reduced by placing Cₐ₀ and C_{g0} closer to the capacitive sense element and reducing series resistance from the first and second sense element nodes to the common node, e.g., reducing the series resistance to less than 1 ohm.

Further, by matching Cₐ₀ and C_{g0} values, e.g., within a defined tolerance, noise caused by the resistance in series with the common node (e.g., in series with Cₐ₀ or C_{g0}) is reduced. In embodiment(s), manufacturing Cₐ₀ and C_{g0} from a common layer on the MEMS chip helps in achieving matching of the Cₐ₀ and C_{g0} values, e.g., within the defined tolerance.

In an embodiment, the first dielectric properties of the first dielectric of the first capacitor (122 (C_{g1})) are equivalent to the third dielectric properties of the third dielectric of the third capacitor (126 (C_{g2})).

In another embodiment, the second dielectric properties of the second dielectric of the second capacitor (C_{g0}) are equivalent to the fourth dielectric properties of the fourth dielectric of the fourth capacitor (Cₐ₀).

In yet another embodiment, a low frequency corner (or cutoff frequency) (e.g., −3 dB point) of a frequency response of the MEMS sensor is determined by the third capacitor (C_{g2}) via the gain adjusting circuit (224).

In one embodiment, the defined bias voltage (V_{b}) is applied from the semiconductor chip 150 via bond pad 161 to the first bond pad (141) such that the capacitive sense element operates in the negative capacitance region. In this regard, operation of a capacitive sense element in a negative capacitance region is described in related patent application Ser. No. 18/066,802, filed on Dec. 15, 2022, and entitled “CONSTANT CHARGE OR CAPACITANCE FOR CAPACITIVE MICRO-ELECTRICAL-MECHANICAL SYSTEM SENSORS”, the entirety of which application is hereby incorporated by reference herein.

In another embodiment, a MEMS device, e.g., a MEMS sensor (101), a MEMS microphone, a MEMS pressure sensor, or a MEMS capacitive micromachined ultrasonic transducer, comprises a MEMS chip (110) comprising a first capacitor (124 (C_{g0})) that comprises a first dielectric comprising a first defined leakage characteristic corresponding to a first defined leakage resistance; a second capacitor (128 (Cₐ₀)) that comprises a second dielectric comprising a second defined leakage characteristic corresponding to a second defined leakage resistance; and a capacitive sense element (130) comprising a first sense element node (210) and a second sense element node (212).

The capacitive sense element comprises a backplate (see, e.g., 1006 in FIG. 10) and a diaphragm (see, e.g., 1004 in FIG. 10) and converts an external pressure that has been applied to the diaphragm into an electrical signal. The first sense element node (210) is electrically connected to a first bond pad (141) of the MEMS chip and is biased via a defined bias voltage (V_{b}) that is externally applied to the first bond pad.

Further, the first sense element node (210) is electrically connected to a first node of the first capacitor (124 (C_{g0}); the second sense element node (212) is electrically connected to a first node of the second capacitor (128 (Cₐ₀)) and a second bond pad (143) of the MEMS chip; and a second node of the first capacitor (124 (C_{g0})) and a second node of the second capacitor (128 (Cₐ₀)) are electrically connected to a third bond pad (145) of the MEMS chip. Further, a semiconductor chip (150) comprises a ground pad (167) that is electrically connected to the third bond pad (145) of the MEMS chip.

In yet another embodiment, the MEMS chip further comprises a third capacitor (122 (C_{g1})) that comprises a third dielectric comprising a third defined leakage characteristic corresponding to a third defined leakage resistance. The first sense element node (210) is electrically connected to a first node of the third capacitor (122 (C_{g1})); a second node of the third capacitor (122 (C_{g1})) is electrically connected to a fourth bond pad (149) of the MEMS chip; and an amplifier (226) of the semiconductor chip is electrically connected, via the fourth bond pad, to the second node of the third capacitor (122 (C_{g1})).

In one embodiment, the MEMS chip further comprises a fourth capacitor (126 (C_{g2})) that comprises a fourth dielectric comprising a fourth defined leakage characteristic corresponding to a fourth defined leakage resistance. A first node of the fourth capacitor (126 (C_{g2})) is electrically connected to the first sense element node (220), and a second node of the fourth capacitor is electrically connected to a fifth bond pad (147) of the MEMS chip.

In another embodiment, a low frequency corner (or cutoff frequency) (e.g., −3 dB point) of a frequency response of the MEMS sensor is determined by the fourth capacitor (126 (C_{g2})) via gain adjusting circuit 224.

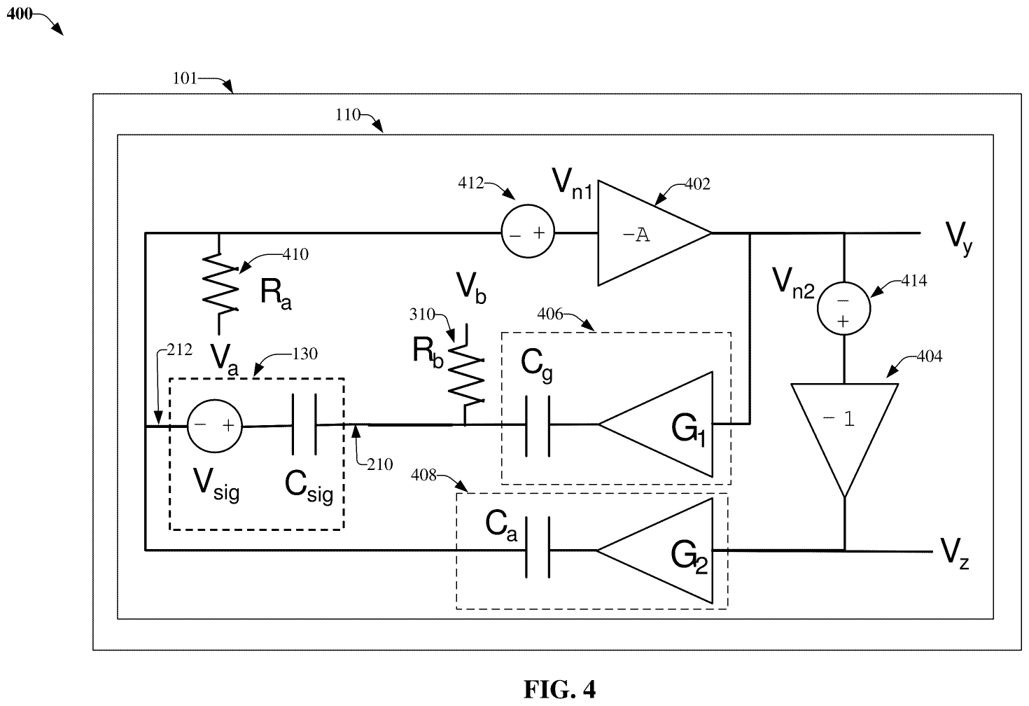

In yet another embodiment, the semiconductor chip comprises a first circuit (gain adjusting circuit 224) that modifies a gain (see, e.g., FIG. 4) of the MEMS sensor according to a configuration, via the fourth bond pad and the fifth bond pad, of respective connections associated with the third capacitor (122 (C_{g1})) and the fourth capacitor (126 (C_{g2})).

In one embodiment, the third dielectric properties of the third dielectric of the third capacitor (122 (C_{g1})) are equivalent to the fourth dielectric properties of the fourth dielectric of the fourth capacitor (126 (C_{g2})).

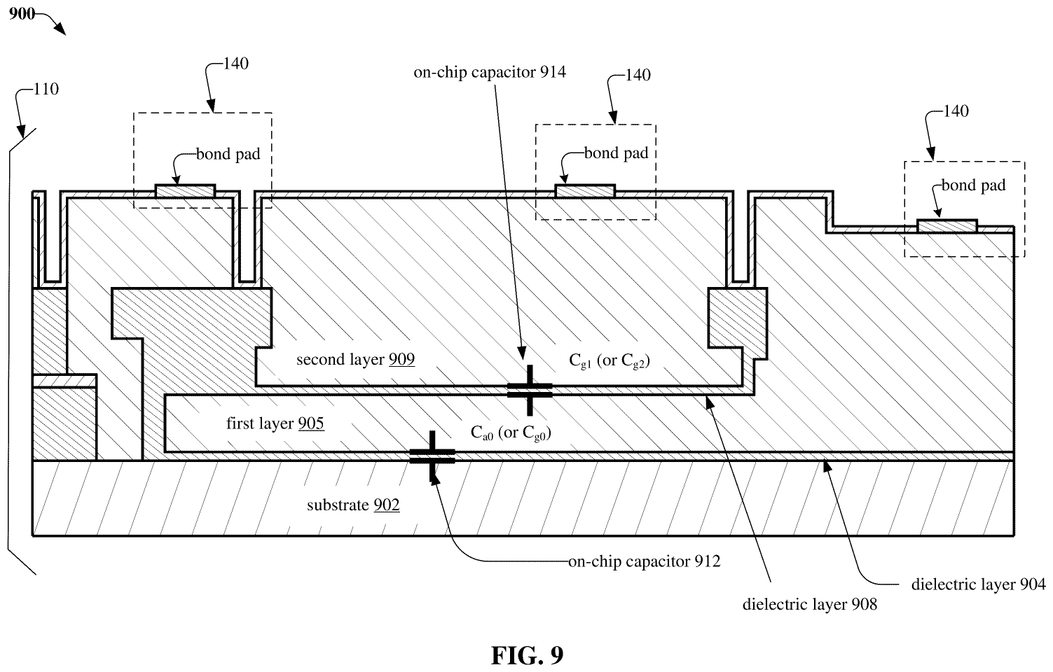

In embodiment(s), matching and/or equivalent dielectric properties of capacitors described herein (e.g., Cₐ₀, C_{g0}, C_{g1}, C_{g2}) can be achieved by utilizing common dielectric layers for the capacitors. Referring now to FIGS. 9-11, detailed placement of such capacitors (e.g., on-chip capacitor 912, on-chip capacitor 914, on-chip capacitor 1114, on-chip capacitor 1116) on the MEMS chip (e.g., 110, 1101) are illustrated, in accordance with various example embodiment(s).

In other embodiment(s), the first dielectric properties of the first dielectric of the first capacitor (124 (C_{g0})) are equivalent to the second dielectric properties of the second dielectric of the second capacitor (128 (Cₐ₀)).

FIG. 4 illustrates a schematic representation (400) of a MEMS sensor (101) in which a capacitive sense element (130) of the MEMS sensor is placed in a feedback loop to improve a stability of the MEMS sensor, in accordance with various example embodiments. A first bias voltage (“Vₐ”) is applied to the second sense element node (212) of the capacitive sense element via a first bias resistance (410 (“Rₐ”)), and a second bias voltage (V_{b}) is applied, via a second bias resistance (310 (“R_{b}”) that is electrically connected to a series resistance (320 (“Rs”)), to the first sense element node (210). In embodiment(s), the series resistance corresponds to a routing resistance that is associated with the first sense element node.

A negative feedback loop between the first sense element node and the second sense element node comprises a first amplifier (402) comprising a negative gain (“−A”) that is electrically connected to a first gain circuit (406). Further, positive feedback is applied the second sense element node via the first amplifier being electrically connected to a second amplifier (404) comprising a negative gain (“−1”) and the second amplifier being electrically connected to a second gain circuit (408). Noise corresponding to the first amplifier is represented by a first voltage noise source (412) (“Vₙ₁”), and noise corresponding to the second amplifier is represented by a second voltage noise source (414) (“Vₙ₂”).

An output, e.g., Vₒ=V_{y}−V_{z}, of the MEMS sensor, e.g., an electrical signal representing an external pressure that has been applied to the diaphragm of the capacitive sense element, can be represented by the following equation (1) that represents a Laplace transfer function from small signal input to small signal output:

$${V}_{y} - {V}_{z} = \frac{2 A ( {V}_{s} + {V}_{r s} - {V}_{n 1} ( 1 + \frac{{C}_{a}}{( {C}_{s} ‖ {C}_{g} )} ) + \frac{{V}_{n 2}}{2} ( ( \frac{1}{A} + {G}_{1} ) + ( \frac{1}{A} + {G}_{2} ) \frac{{C}_{a}}{( {C}_{s} ‖ {C}_{g} )} ) - \frac{{V}_{a}}{s {R}_{a} ( {C}_{s} ‖ {C}_{g} )} - \frac{{V}_{b}}{{sR}_{b} {C}_{g}} )}{( 1 + A {G}_{1} ) + ( 1 - A {G}_{2} ) \frac{{C}_{a}}{( {C}_{s} ‖ {C}_{g} )}} ; \qquad ( 1 )$$

in which
   All voltages in FIG. 4 are small signal sources;
   A represents a gain of the first amplifier;
   Vs represents voltage variation due to changes in pressure;
   Vᵣₛ represents noise associated with resistance in series with the capacitive sense element (130);
   Vₙ₁ represents the first voltage noise source (412) corresponding to the first amplifier (402);
   Vₙ₂ represents the second voltage noise source (414) corresponding to the second amplifier (404);
   Cₐ represents a value of a capacitance of the second gain circuit (408);
   G₁ represents a value of a gain of the first gain circuit (406);
   Cₛ represents the small signal capacitance (C_{sig}) of the MEMS capacitance at the bias point;
   C_{g} represents a value of a capacitance of the first gain circuit (406);
   G₂ represents a value of a gain of the second gain circuit (408);
   Rₐ represents a value of bias resistance (410) applied to the second sense element node (212);
   Vₐ represents a value of bias voltage applied to Rₐ;
   R_{b} represents a value of bias resistance (310) applied to a first sense element node (210);
   V_{b} represents a value of bias voltage applied to R_{b};
   s represents a complex frequency variable; and
   Cₛ∥C_{g} represents a series equivalent capacitance of Cs and Cg.

At bias,

$$( \frac{1}{{C}_{s i g}} + \frac{1}{{C}_{a}} + \frac{1}{{C}_{g}} = 0 ) ,$$

the following equation (2) results:

$${V}_{y} - {V}_{z} = \frac{2}{{G}_{1} + {G}_{2}} ( {V}_{s} + {V}_{r s} - {V}_{n 1} ( 1 + \frac{{C}_{a}}{( {C}_{s} ‖ {C}_{g} )} ) + \frac{{V}_{n 2}}{2} ( {G}_{1} - {G}_{2} ) + \frac{{V}_{a}}{s {R}_{a} {C}_{a}} - \frac{{V}_{b}}{s {R}_{b} {C}_{g}} ) . \qquad ( 2 )$$

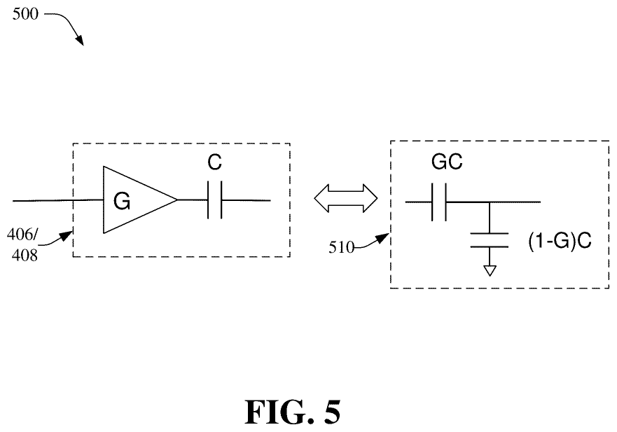

FIG. 5 illustrates a schematic representation (500) of a gain circuit (406, 408) represented as a capacitive divider (510); and FIG. 6 illustrates a schematic representation (600) of an architecture of a MEMS chip (110) of a MEMS sensor (101) in which gain stages of respective feedback loops of the MEMS sensor are implemented as respective capacitive dividers (610, 620) according to the following equations (3)-(6):

$${C}_{a 1} = {G}_{2} {C}_{a} ; \qquad ( 3 )$$

$${C}_{a 0} = ( 1 - {G}_{2} ) {C}_{a} ; \qquad ( 4 )$$

$${C}_{g 1} = {G}_{1} {C}_{g} ; and \qquad ( 5 )$$

$${C}_{g 0} = ( 1 - {G}_{1} ) {C}_{g} . \qquad ( 6 )$$

In this regard, a first gain circuit (408) is implemented in the MEMS chip as a first capacitive divider (610) that comprises capacitor 602 (“Cₐ₁”) and capacitor 604 (“Cₐ₀”); and a second gain circuit (406) is implemented in the MEMS chip as a second capacitive divider (620) that comprises capacitor 122 (“C_{g1}”) and capacitor (“C_{g0}”).

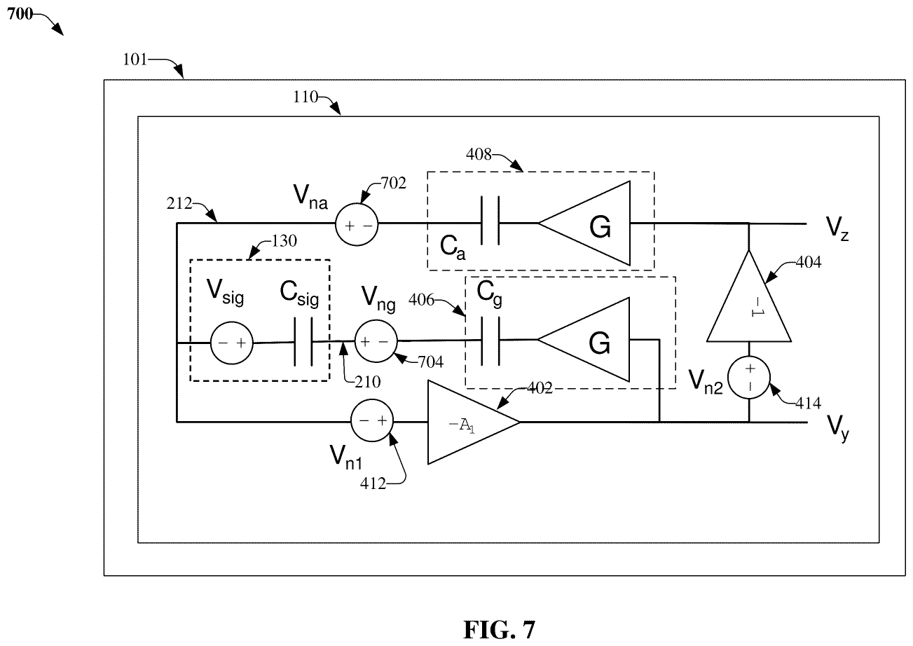

FIG. 7 illustrates a schematic representation (700) of noise sources (412, 414, 702, 704) of a MEMS chip (110) of a MEMS sensor (101), in accordance with various embodiments. The following equations (7)-(8) represent relationships corresponding to the schematic representation of the noise sources:

$${V}_{y} = \frac{\frac{{V}_{s i g}}{{C}_{a}} - \frac{{V}_{ng}}{{C}_{a}} - \frac{{V}_{na}}{( {C}_{sig} ‖ {C}_{g} )} - {V}_{n 1} ( \frac{1}{{C}_{a}} + \frac{1}{{C}_{sig} ‖ {C}_{g}} ) + {V}_{n 2} G \frac{1}{( {C}_{sig} ‖ {C}_{g} )}}{\frac{1}{{A}_{1}} ( \frac{1}{{C}_{a}} + \frac{1}{{C}_{sig} ‖ {C}_{g}} ) + G ( \frac{1}{{C}_{a}} - \frac{1}{{C}_{sig} ‖ {C}_{g}} )} . \qquad ( 7 )$$

$$\begin{matrix}At \frac{1}{{C}_{a}} + \frac{1}{{C}_{sig} ‖ {C}_{g}} = 0 , \\ {V}_{y} = \frac{1}{2 G} ( {V}_{s i g} - {V}_{n g} + {V}_{n a} - {V}_{n 2} G ) ; \\ {V}_{z} = \frac{1}{2 G} ( - {V}_{s i g} + {V}_{n g} - {V}_{n a} - {V}_{n 2} G ) ; and \\ {V}_{y} - {V}_{z} = \frac{1}{G} ( {V}_{s i g} + {V}_{n a} - {V}_{n g} ) ;\end{matrix} \qquad ( 8 )$$

in which
   Vₙ₁ represents the first voltage noise source (412) corresponding to the first amplifier (402);
   Vₙ₂ represents the second voltage noise source (414) corresponding to the second amplifier (404);
   Vₙₐ represents a first routing noise source (702) representing routing noise associated with resistances in series with the capacitors coupled to the second sense element node (212); and
   V_{ng} represents a second routing noise source (704) representing routing noise associated with resistances in series with the capacitors coupled to the first sense element node (210).

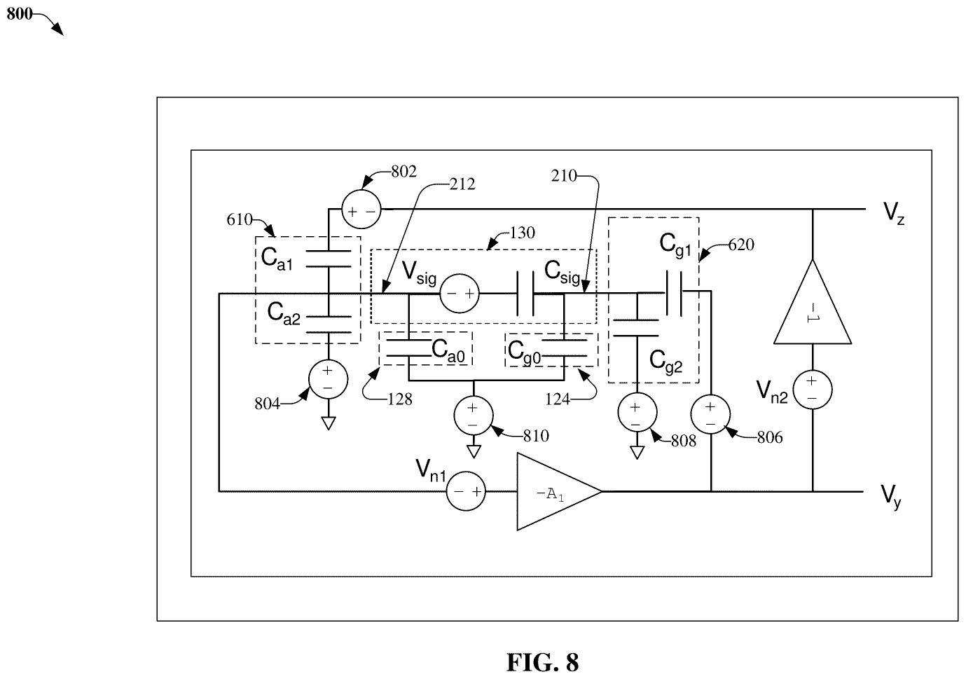

FIG. 8 illustrates a schematic representation (800) of a MEMS chip (110, 1101) of a MEMS sensor (101) representing routing noise sources (802, 804, 806, 808, 810) corresponding to resistances in series with respective capacitances (Cₐ₀, C_{g0}, Cₐ₁, Cₐ₂, C_{g1}, C_{g2}) that are coupled to a capacitive sense element (130) of the MEMS chip, in accordance with various embodiments.

The routing noise sources Vₙₐ and V_{ng} can be represented by the following equations (9)-(11):

$${V}_{n a} = {V}_{n 0} ( \frac{{C}_{a o}}{{C}_{a t o t a l}} ) + {V}_{n a 1} ( \frac{{C}_{a 1}}{{C}_{a t o t a l}} ) + {V}_{n a 2} ( \frac{{C}_{a 2}}{{C}_{a t o t a l}} ) ; \qquad ( 9 )$$

$${V}_{n g} = {V}_{n 0} ( \frac{{C}_{g 0}}{{C}_{g t o t a l}} ) + {V}_{n g 1} ( \frac{{C}_{g 1}}{{C}_{g t o t a l}} ) + {V}_{n g 2} ( \frac{{C}_{g 2}}{{C}_{g t o t a l}} )$$

$${V}_{n a} - {V}_{n g} = {V}_{n 0} ( \frac{{C}_{a o}}{{C}_{a t o t a l}} - \frac{{C}_{g 0}}{{C}_{g t o t a l}} ) + {V}_{n a 1} ( \frac{{C}_{a 1}}{{C}_{a t o t a l}} ) + {V}_{n a 2} ( \frac{{C}_{a 2}}{{C}_{a t o t a l}} ) - {V}_{n g 1} ( \frac{{C}_{g 1}}{{C}_{g t o t a l}} ) - {V}_{n g 2} ( \frac{{C}_{g 2}}{{C}_{g t o t a l}} ) ; \qquad ( 11 )$$

in which
   Vₙₐ₁ corresponds to routing noise source 802;
   Vₙₐ₂ corresponds to routing noise source 804;
   V_{g1} corresponds to routing noise source 806;
   V_{g2} corresponds to routing noise source 808; and
   Vₙ₀ corresponds to routing noise source 810.

FIGS. 9-11 illustrate diagrams of cross-sections (900, 1000, 1100) of respective MEMS chips (110, 1101) of respective MEMS sensors (e.g., 101), in which the MEMS chips comprise on-chip capacitors (e.g., on-chip capacitor 912, on-chip capacitor 914, on-chip capacitor 1114, on-chip capacitor 1116), in accordance with various example embodiments. As illustrated by FIGS. 9 and 10, a MEMS chip (110) comprises a substrate layer (e.g., substrate 902, 1002) that comprises an acoustic port (1008); and a capacitive sense element (130) comprising a backplate layer (e.g., second layer 909, backplate 1006) and a diaphragm layer (e.g., first layer 905, diaphragm 1004), in which the capacitive sense element converts an external pressure that has been applied to the diaphragm layer via the acoustic port into an electrical signal, and the backplate layer and the diaphragm layer are disposed over the substrate layer.

The MEMS chip further comprises an on-chip capacitor 912 (e.g., C_{g0}, Cₐ₀) comprising a dielectric layer (e.g., 904) that is disposed between a portion of the substrate layer (e.g., 902) and the diaphragm layer (e.g., 905).

In other embodiments, the MEMS chip further comprises on-chip capacitor 914 (e.g., C_{g1}, C_{g2}) comprising a dielectric layer (e.g., 908) that is disposed between a portion of the backplate layer (e.g., 909) and the diaphragm layer (e.g., 905). In embodiments(s), the second layer 909 can be a diaphragm or a backplate.

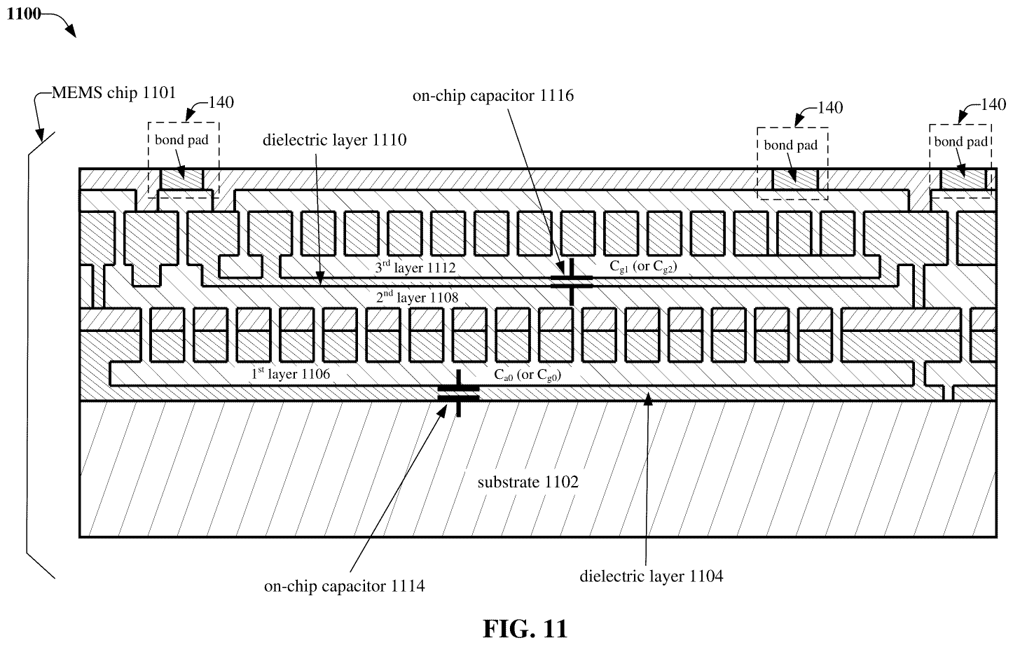

Referring now to embodiments illustrated by FIG. 11, a MEMS chip (1101) comprises a first on-chip capacitor (1114) (e.g., Cₐ₀, C_{g0}) comprising a first dielectric layer (1104) that is disposed between a substrate (1102) and a first (1^{st}) layer (1106). Further, the MEMS chip comprises a second on-chip capacitor (1116) (e.g., C_{g1}, C_{g2}) comprising a second dielectric layer (1110) that is disposed between a second (2^{nd}) layer (1108) and a third (3^{rd}) layer (1112).

In embodiment(s), the 2^{nd} layer (909,1108) can comprise a diaphragm or a backplate and the 3^{rd} (1112) layer can comprise a backplate.

In other embodiment(s), the 1^{st}, 2^{nd} and 3^{rd} layers (905, 909, 1106, 1108, 1112) can comprise polysilicon, epi-silicon, and/or silicon-germanium.

In embodiments, the first dielectric layer and the second dielectric layer comprise respective dielectric materials comprising respective defined leakage characteristics corresponding to respective defined leakage resistances.

In other embodiments, the respective dielectric materials comprise a thermal oxide and/or a high stress silicon nitride.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A micro-electro-mechanical system (MEMS) sensor, comprising:
a MEMS chip comprising a capacitor that comprises a dielectric comprising a defined leakage characteristic corresponding to a defined leakage resistance, and
a capacitive sense element comprising a first sense element node and a second sense element node,
wherein the capacitive sense element comprises a backplate and a diaphragm and converts an external pressure that has been applied to the diaphragm into an electrical signal,
wherein the first sense element node is electrically connected to a first bond pad of the MEMS chip and is biased via a defined bias voltage that is externally applied to the first bond pad,
wherein the first sense element node is electrically connected to a first node of the capacitor,
wherein a second node of the capacitor is electrically connected to a second bond pad of the MEMS chip, and
wherein the second sense element node is electrically connected to a third bond pad of the MEMS chip; and
a semiconductor chip comprising an amplifier that is electrically connected, via the second bond pad, to the second node of the capacitor.

2. The MEMS sensor of claim 1, wherein the capacitor is a first capacitor,
wherein the dielectric is a first dielectric,
wherein the defined leakage characteristic is a first defined leakage characteristic, wherein the defined leakage resistance is a first defined leakage resistance,
wherein the MEMS chip further comprises a second capacitor that comprises a second dielectric comprising a second defined leakage characteristic corresponding to a second defined leakage resistance,
wherein the first sense element node is electrically connected to a first node of the second capacitor, and
wherein a second node of the second capacitor is electrically connected to a fourth bond pad of the MEMS chip.

3. The MEMS sensor of claim 2, wherein the fourth bond pad is electrically connected to a ground pad of the semiconductor chip.

4. The MEMS sensor of claim 2, further comprising:
a third capacitor that comprises a third dielectric comprising a third defined leakage characteristic corresponding to a third defined leakage resistance, wherein a first node of the third capacitor is electrically connected to the first sense element node, and wherein a second node of the third capacitor is electrically connected to a fifth bond pad of the MEMS chip.

5. The MEMS sensor of claim 4, wherein the semiconductor chip comprises a gain adjusting circuit that modifies a gain on the MEMS sensor over a range of frequencies.

6. The MEMS sensor of claim 4, further comprising:
a fourth capacitor that comprises a fourth dielectric comprising a fourth defined leakage characteristic corresponding to a fourth defined leakage resistance,
wherein the second sense element node is electrically connected to a first node of the fourth capacitor, and
wherein a second node of the fourth capacitor is electrically connected to the fourth bond pad that is electrically connected to the second node of the second capacitor.

7. The MEMS sensor of claim 4, wherein first dielectric properties of the first dielectric of the first capacitor are the same as third dielectric properties of the third dielectric of the third capacitor.

8. The MEMS sensor of claim 6, wherein second dielectric properties of the second dielectric of the second capacitor are the same as fourth dielectric properties of the fourth dielectric of the fourth capacitor.

9. The MEMS sensor of claim 4, wherein a low frequency corner of a frequency response of the MEMS sensor is determined by the third capacitor.

10. The MEMS sensor of claim 1, wherein the defined bias voltage is externally applied to the first bond pad such that the capacitive sense element operates in a negative capacitance region.

11. The MEMS sensor of claim 1, wherein the external pressure comprises a sound pressure, an atmospheric pressure, or an ultrasonic pressure.

12. The MEMS sensor of claim 1, wherein the capacitive sense element comprises a sealed cavity that has been formed between the backplate and the diaphragm.

13. The MEMS sensor of claim 12, wherein the sealed cavity comprises a pressure that is less than 100 pascals.

14. The MEMS sensor of claim 1, wherein a shape of the diaphragm is circular, donut-shaped, or rectangular, and
wherein a portion of the backplate comprises an electrode comprising an array of pillars that is formed along the shape of the diaphragm.

15. A micro-electro-mechanical system (MEMS) device, comprising:
a MEMS chip comprising
a first capacitor that comprises a first dielectric comprising a first defined leakage characteristic corresponding to a first defined leakage resistance,
a second capacitor that comprises a second dielectric comprising a second defined leakage characteristic corresponding to a second defined leakage resistance, and
a capacitive sense element comprising a first sense element node and a second sense element node,
wherein the capacitive sense element comprises a backplate and a diaphragm and converts an external pressure that has been applied to the diaphragm into an electrical signal,
wherein the first sense element node is electrically connected to a first bond pad of the MEMS chip and is biased via a defined bias voltage that is externally applied to the first bond pad,
wherein the first sense element node is electrically connected to a first node of the first capacitor,
wherein the second sense element node is electrically connected to a first node of the second capacitor and a second bond pad of the MEMS chip, and
wherein a second node of the first capacitor and a second node of the second capacitor are electrically connected to a third bond pad of the MEMS chip; and
a semiconductor chip comprising a ground pad that is electrically connected to the third bond pad of the MEMS chip.

16. The MEMS device of claim 15, wherein the MEMS chip further comprises:
a third capacitor that comprises a third dielectric comprising a third defined leakage characteristic corresponding to a third defined leakage resistance, wherein the first sense element node is electrically connected to a first node of the third capacitor,
wherein a second node of the third capacitor is electrically connected to a fourth bond pad of the MEMS chip, and
wherein an amplifier of the semiconductor chip is electrically connected, via the fourth bond pad, to the second node of the third capacitor.

17. The MEMS device of claim 16, further comprising:
a fourth capacitor that comprises a fourth dielectric comprising a fourth defined leakage characteristic corresponding to a fourth defined leakage resistance, wherein a first node of the fourth capacitor is electrically connected to the first sense element node, and wherein a second node of the fourth capacitor is electrically connected to a fifth bond pad of the MEMS chip.

18. The MEMS device of claim 17, wherein the semiconductor chip comprises a gain adjusting circuit that modifies a gain of the MEMS sensor.

19. The MEMS device of claim 18, wherein a low frequency corner of a frequency response of the MEMS sensor is determined by the fourth capacitor.

20. The MEMS device of claim 17, wherein the third dielectric properties of the third dielectric of the third capacitor are equivalent to the fourth dielectric properties of the fourth dielectric of the fourth capacitor.

21. The MEMS device of claim 15, wherein the first dielectric properties of the first dielectric of the first capacitor are equivalent to the second dielectric properties of the second dielectric of the second capacitor.

22. The MEMS device of claim 15, wherein the defined bias voltage is externally applied to the first bond pad such that the capacitive sense element operates in a negative capacitance region.

23. The MEMS device of claim 15, wherein the external pressure comprises a sound pressure, an atmospheric pressure, or an ultrasonic pressure.

24. The MEMS device of claim 15, wherein the capacitive sense element comprises a sealed cavity that has been formed between the backplate and the diaphragm.

25. The MEMS device of claim 24, wherein the sealed cavity comprises a pressure that is less than 100 pascals.

26. The MEMS device of claim 15, wherein a shape of the diaphragm is circular, donut-shaped, or rectangular, and wherein a portion of the backplate comprises an electrode comprising an array of pillars that is formed along the shape of the diaphragm.

27. A micro-electro-mechanical system (MEMS) sensor, comprising:
a substrate layer comprising an acoustic port;
a capacitive sense element comprising a backplate layer and a diaphragm layer, wherein the capacitive sense element converts an external pressure that has been applied to the diaphragm layer via the acoustic port into an electrical signal, and wherein the backplate layer and the diaphragm layer are disposed over the substrate layer; and
a capacitor comprising a dielectric layer that is disposed between a portion of the substrate layer and the diaphragm layer.

28. The MEMS sensor of claim 27, wherein the diaphragm layer comprises at least one of polysilicon, epi-silicon, or silicon-germanium.

29. The MEMS sensor of claim 27, wherein the dielectric layer is a first dielectric layer, and wherein the MEMS sensor further comprises:
a polysilicon layer that is disposed over the diaphragm layer; and
a second capacitor comprising a second dielectric layer that is disposed between the diaphragm layer and the polysilicon layer.

30. The MEMS sensor of claim 29, wherein the first dielectric layer and the second dielectric layer comprise respective dielectric materials comprising respective defined leakage characteristics corresponding to respective defined leakage resistances.

31. The MEMS sensor of claim 30, wherein the respective dielectric materials comprise at least one of a thermal silicon dioxide or a high stress silicon nitride.

32. The MEMS sensor of claim 27, further comprising:
a second polysilicon layer that is disposed between the diaphragm and the backplate; and
a second capacitor comprising a second dielectric layer that is disposed on the second polysilicon layer and the backplate.
